(19) United States
(12) Patent Application Publication
(10) Pub. No.: US 2012/0126911 A1
(43) Pub. Date: May 24, 2012

(54) ELECTROMAGNETIC WAVE ISOLATOR

(75) Inventor: Walter R. Romanko, Austin, TX (US)

(73) Assignee: 3M Innovative Properties Company

(21) Appl. No.: 13/289,635

(22) Filed: Nov. 4, 2011

Related U.S. Application Data
(60) Provisional application No. 61/415,090, filed on Nov. 18, 2010.

(51) Int. Cl. H01P 1/36

(52) U.S. Cl. 333/24.2

(57) ABSTRACT

Provided is an electromagnetic wave isolator having at least one microstructured surface, which provides a change in electromagnetic properties across the depth of the microstructured surface.

### CROSS REFERENCE TO RELATED APPLICATION

This application claims the benefit of U.S. Provisional Patent Application No. 61/415,090, filed Nov. 18, 2010, the disclosure of which is incorporated by reference herein in its entirety.

### TECHNICAL FIELD

This invention relates to an electromagnetic wave isolator having a microstructured surface.

### BACKGROUND

Radio Frequency Identifier (RFID) tags are used in a variety of applications, such as inventory control and security. These RFID tags are typically placed on or in articles, or containers such as cardboard boxes. The RFID tags work in conjunction with an RFID base station or reader. The reader supplies an electromagnetic wave output, which acts at a particular carrier frequency. The signal transmitted from the reader couples with the RFID tag antenna to produce a current in the antenna. The antenna current creates backscattered electromagnetic waves which are emitted at the frequency of the reader. Most RFID tags contain integrated circuits, which are capable of storing information. These integrated circuits have a minimum voltage requirement below which they cannot function and the tag cannot be read. Some of the current in the RFID antenna is utilized to power up the RFID tag's integrated circuit via a voltage differential across the antenna, and the integrated circuit then uses this power to modulate the backscattered signal as information specific to the tag. An RFID tag that is proximate to the reader will receive ample energy and therefore be able to supply sufficient voltage to its integrated circuit, as contrasted to a RFID tag which is physically farther away from the reader. The maximum distance between the reader and the RFID tag at which the RFID tag can still be read is known as the read distance. Obviously, greater read distances are beneficial to nearly all RFID applications.

RFID systems operate at a number of different frequency regions for commercial RFID applications. The low frequency (LF) range is around 125-150 kHz. The high frequency (HF) range is 13.56 MHz, and the ultra high frequency (UHF) region includes 850-950 MHz, 2450 MHz, and 5.8 GHz super high frequency region (SHF).

One benefit of RFID tags that operate in the ultra high frequency (UHF) range is the potential to have much greater read distances than tags operating at low or high frequency. Unfortunately, ultra high frequency RFID tags cannot be read when the tag is in close proximity to a metal substrate or a substrate with high water content. Thus, an RFID tag attached to a metal container or to a bottle containing a conductive liquid, e.g., a soft drink, cannot be read from any distance.

### SUMMARY

At least one embodiment of the present invention provides an electromagnetic wave isolator that can be used, e.g., with high frequency RFID tags in conjunction with substrates that can interfere with the operation of the RFID tags, particularly metal substrates as well as substrates used to contain liquid.

At least one embodiment of the present invention provides an article comprising an electromagnetic wave isolator comprising at least a first section having first and second major surfaces and an adjacent second section having first and second surfaces, wherein at least one of the sections has a microstructured major surface.

At least one embodiment of the present invention provides an article comprising an electromagnetic wave isolator comprising at least a first section having first and second major surfaces and an adjacent second section having first and second surfaces, wherein at least one of the sections has microstructured features on at least one major surface; and a component that does one or both of receive an electromagnetic wave and generate an electromagnetic wave, the component coupled to the electromagnetic wave isolator; wherein the length of the wave generated or received by the component is greater than the periodicity of the microstructured features on at least one major surface of a section of the electromagnetic wave isolator.

As used in this invention:

“microstructured” means having structural elements or features on a surface, at least one of the dimensions of which elements or features, e.g., height, width, depth, and periodicity are on the micrometer scale, e.g., between about 1 micrometer and about 2000 micrometer;

“high permittivity” means having a permittivity of greater than 5; and

“high permeability” means having a permeability greater than 3

An advantage of at least one embodiment of the present invention is an isolator that provides a longer read distance for a given isolator thickness.

Another advantage of at least one embodiment of the present invention is an isolator that provides a thinner isolator for a given read distance.

The above summary of the present invention is not intended to describe each disclosed embodiment or every implementation of the present invention. The Figures and detailed description that follow below more particularly exemplify illustrative embodiments.

### BRIEF DESCRIPTION OF DRAWINGS

FIG. 1 depicts an embodiment of an electromagnetic wave isolator of the present invention.

FIGS. 2a-2l depict different schematic cross-sections of embodiments of electromagnetic wave isolators of the present invention made with two or more materials.

FIG. 3 depicts an embodiment of an electromagnetic wave isolator of the present invention.

FIG. 4 depicts an embodiment of an electromagnetic wave isolator of the present invention having asymmetric stepped pyramid microstructured features.

FIG. 5 depicts a schematic cross-section of an embodiment of an electromagnetic wave isolator of the present invention having paraboloidal microstructured features.

FIG. 6 depicts top and side views of an embodiment of an electromagnetic wave isolator of the present invention.

FIG. 7 depicts an embodiment of an electromagnetic wave isolator of the present invention having tetrahedral microstructured features.

FIG. 8 depicts an embodiment of an electromagnetic wave isolator of the present invention having cylindrical post microstructured features.

FIG. 9 depicts a schematic cross-section of an embodiment of an electromagnetic wave isolator of the present invention having bimodal microstructured features.

FIG. 10 depicts an embodiment of an RFID tag system including an electromagnetic wave isolator of the present invention.

FIG. 11 depicts a graph comparing the thickness of isolators of the present invention and comparative articles to their read ranges.

FIG. 12 depicts a graph comparing the thickness of isolators of the present invention and comparative articles to their read ranges.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

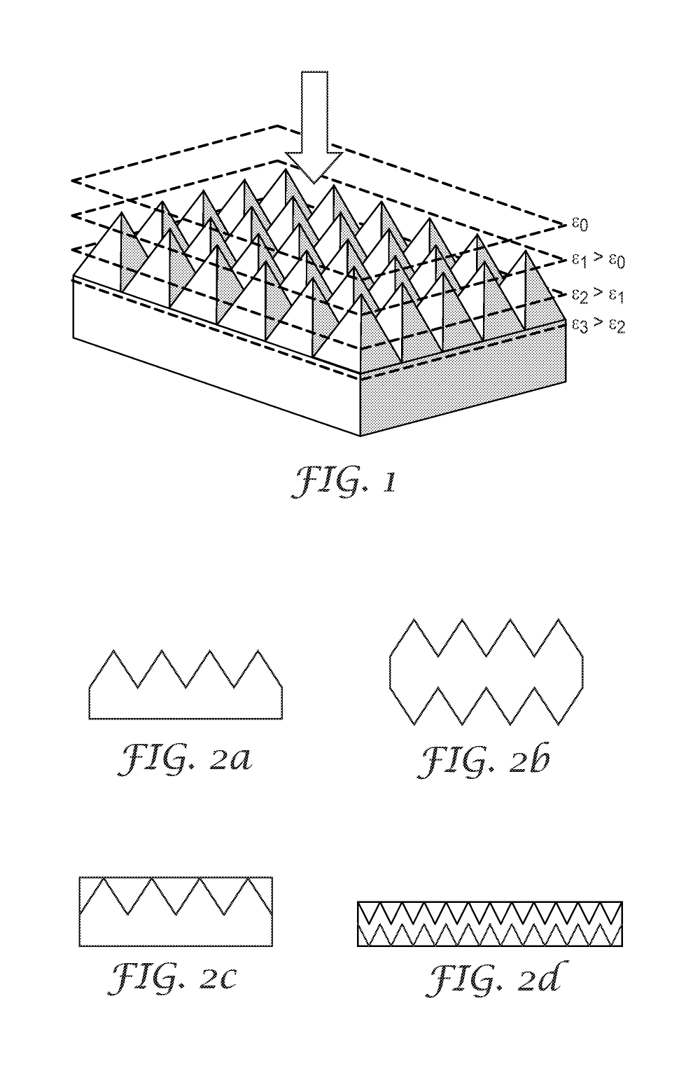

One aspect of the present invention is an electromagnetic wave isolator having at least one microstructured surface or interface. The microstructured surface or interface provides a change in electromagnetic properties across the depth of the microstructured portion(s). The change may be a gradual change or a step change. The electromagnetic wave isolators of the present invention achieve this change in electromagnetic properties, at least in part, due to its physical features. This is in contrast to prior art electromagnetic wave isolators which achieve a change in electromagnetic properties across the depth of the isolator due to a change in electromagnetic properties of the materials used to make each layer of the isolator or by a compositional gradient within a specific layer of the isolator. FIG. 1 illustrates an electromagnetic wave isolator of the present invention having a pyramidal microstructured surface and indicates some exemplary planes of equivalent permittivity (ε₀; ε₁>ε₀; ε₂>ε₁; and ε₃>ε₂) in the microstructured portion. Other electromagnetic properties, such as permeability, would correspondingly have similar variations. In at least one embodiment, the microstructured portion effectively provides an electromagnetic property gradient when at least one of the microstructured features' periodicity is, or periodicity and height are, less than the electromagnetic wavelength within the isolator material. For electromagnetic wavelengths much greater than the microstructured periodicity, the microstructured portion(s) will create a medium in which the electromagnetic property varies depending on the geometry of the surface or interface of the microstructured portion from that of free space (or a different material) to that of the base portion, i.e., the portion of the microstructured isolator section adjacent to the microstructured portion, made of the same material as the microstructured portion but containing no microstructured features. With proper matching of the electromagnetic properties, the microstructured pattern, the overall isolator thickness, and the ratio of microstructured portion thickness to base portion thickness, the reflectance and/or isolator characteristics of the construction can be enhanced for a particular antenna design. For electromagnetic frequencies in which the wavelength in the isolator medium is less than the periodicity of the microstructured pattern, in at least one embodiment of the present invention, the microstructured features serve as a method of changing the effective electromagnetic properties within that region in the isolator construction. The wavelength in the isolator medium is given by λₒ(εᵣμᵣ)^{-1/2}. For an isolator with εᵣ=300, μᵣ=1, and microstructured features with a periodicity of 2 mm, the cut-off frequency is about 9 GHz. An isolator with a microstructured pyramidal array would behave as if it had a continuously varying permittivity within the microstructured region for electromagnetic radiation lower than about 9 GHz. Above about 9 GHz, the microstructured features will behave more as discrete structures. For an isolator with εᵣ=30, μᵣ=1, and microstructured features with a periodicity of 0.3 mm, the cut-off frequency is about 200 GHz.

In at least one embodiment of the present invention, the microstructured surface creates (or provides) an interface that is not parallel to the overall plane of the antenna, the interface and adjacent three dimensional features of the isolator on both sides of the interface defining volumes comprising materials of contrasting electromagnetic properties.

At least one embodiment of the electromagnetic wave isolator of the present invention comprises a binder material loaded with a high permittivity and/or high permeability filler material formed into a construction such that at least one surface has a repeating array of features. The high permittivity and/or high permeability filler-loaded binder material can be formed into continuous microstructured films or sheets, as in a web-based process, or it can be utilized in a process producing individual parts, such as those designed for a very specific shape or application. Typically, the material will comprise about 80 wt % to about 95 wt % filler. However, the amounts are highly dependent on the specific gravities of the binder and filler, as well as other parameters such as particle shape, compatibility of the particle with binder, type of manufacturing process, whether and what type of solvent is used, etc.

In at least one embodiment of the present invention, a binder (typically at a small concentration) can be blended with high permittivity or high permeability material, the microstructured pattern can be formed, the binder can be evaporated or burned off, and the construction can be sintered.

Suitable binders include thermoplastics, thermosets, curable liquids, thermoplastic elastomers, or other known materials for dispersing and binding fillers. Specific suitable materials include relatively non-polar materials such as polyethylene, polypropylene, silicone, silicone rubber, polyolefin copolymers, EPDM, and the like; polar materials such as chlorinated polyethylene, acrylate, polyurethane, and the like; and curable materials such as epoxies, acrylates, urethanes, and the like; and non-curable materials. The binder materials used to make the isolators of the present invention may be loaded with different types of low dielectric constant fillers, including glass bubbles, air (e.g., to create a foam), and polytetrafluoroethylene (PTFE), such as TEFLON. PTFEs, such as TEFLON, may also be used by itself as a binder. The materials used to make one or more sections of the isolators of the present invention may also be loaded with small concentration of compatibilizer-treated nanoparticles, such as those described in US Pat. Publication No. 2008/0153963, blended with the high dielectric constant or high permeability filler to allow the filler to flow more freely and blend into a binder, if used, allowing more effective blending at higher concentrations of particles.

The materials used to make one or more sections of the isolators of the present invention may be loaded with soft magnetic materials such as ferrite materials (CO2Z from Trans-Tech Inc), an iron/silicon/aluminum material referred to by the trade name SENDUST but also available under other trade designations such as KOOL Mu (Magnetics Inc, www.mag-inc.com), an iron/nickel material available under the trade designation PERMALLOY or its iron/nickel/molybdenum cousin MOLYPERMALLOY from Carpenter Technologies Corporation (www.cartech.com), and carbonyl iron, which may be unannealed, annealed, and optionally treated with phosphoric acid or some other surface passivating agent. The soft magnetic material may have various geometries such as spheres, plates, flakes, rods, fibers, amorphous, and may be micro- or nano-sized.

Alternatively, the materials used to make one or more sections of the isolators of the present invention may be loaded with different types of high dielectric constant fillers, including barium titanate, strontium titanate, titanium dioxide, carbon black, or other known high dielectric constant materials, including the carbon decorated barium titanate material described in U.S. Provisional Pat. App. No. 61/286,247. Nano-sized high dielectric constant particles and/or high dielectric constant conjugated polymers may also be used. Blends of two or more different high dielectric constant materials or blends of high dielectric constant materials and soft magnetic materials such as carbonyl iron may be used.

In at least one embodiment of the present invention, instead of using a binder and high dielectric constant material, an example of one suitable material is a polyaniline/epoxy blend having a dielectric constant of around 3000 (J. Lu et al., “High dielectric constant polyaniline/epoxy composites via in situ polymerization for embedded capacitor applications”, Polymer, 48 (2007), 1510-1516).

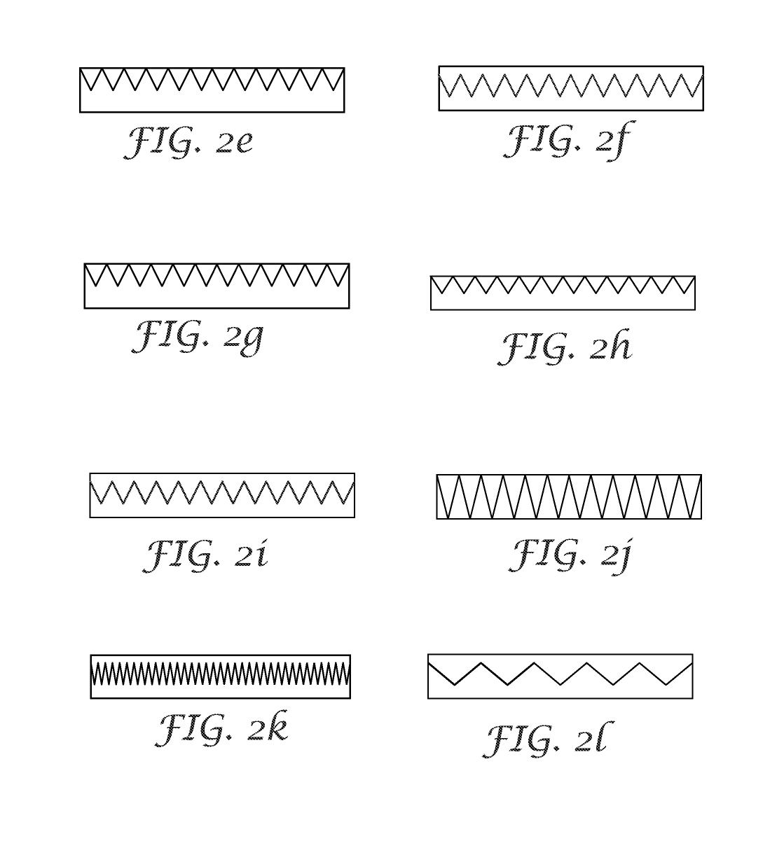

Microstructured patterns may be present on one outer surface of an isolator of the present invention; on both outer surfaces of the isolator with the same pattern; or on both outer surfaces of the isolator with different patterns and/or periodicities. Microstructured patterns may be present within the isolators of the present inventions at interfaces of sections comprising different materials. The microstructured patterns may be present at one or more interface within the isolator. If there is more than one interface, the patterns may be the same or different for the different interfaces. FIGS. 2a-2l illustrate different embodiments of the invention showing some of these variations. FIG. 2a shows an article with one microstructured surface. FIG. 2b shows an article with two opposing microstructured surfaces. FIG. 2c shows an article with one microstructured interface. An interface is typically formed by creating a first section having microstructured features on a surface, then filling the open areas created by the microstructured features with a material different from the material forming the section having the microstructured surface. In at least one embodiment of the present invention, the different material may have a different permittivity and/or different permeability that the material forming the first section. The different material can be used to more finely tune the isolator for an intended application. In at least one embodiment of the present invention, the materials forming the first and second sections (and optionally additional sections) will have different permeabilities, the permeability values for the two sections having a ratio of about 3 to about 1000. In at least one embodiment of the present invention, the materials forming the first and second sections (and optionally additional sections) will have different permittivities, the permittivity values for the two sections having a ratio of about 2.5 to about 1000. The different material may be any suitable material that can provide the desired electromagnetic properties, and includes but is not limited to, polymers, resins, adhesives, etc. They may optionally comprise a filler for tuning the electromagnetic properties of the system. As an alternative to filling the open areas with a material, the open areas can be left empty, in which case air functions as the different material. See, e.g., FIGS. 2a and 2b. When the different material fills in the open areas around the microstructured surface (thus forming an interface), the electromagnetic properties will change from one outer surface of the article through to the other outer surface in accordance with the geometry of the microstructured surface or interface and the properties of the materials forming the various sections of the isolator. The isolator may optionally comprise an adhesive section on one or both outer surfaces or an adhesive could form an interior section between two non-adhesive sections. An adhesive may be used as the different material filling the open areas created by the microstructured features. If the material forming an outer surface of the isolator is not an adhesive, an adhesive layer may be applied to the isolator article to secure it to an object.

The isolator article may also include a metallic or conductive layer such that regardless of the object against which the isolator and, e.g., an accompanying tag or antenna are placed, the antenna or tag would have the same read range. In such a case, the antenna- or -tag/isolator portion would be tuned to operate well with the metallic layer present, and the system would then operate equally well whether placed against a metallic article or a low permittivity material such as corrugated cardboard.

As previously stated, an article having one or more microstructured surfaces or interfaces may have two or more sections, the sections comprising materials having different permittivities and/or permeabilities. FIG. 2d illustrates an example of a three section/two interface article of the present invention in which each of the three sections comprises a different material and has different properties. Embodiments of articles of the present invention may have a myriad of different constructions. For example, FIGS. 2e and 2f illustrate articles of the present invention having the same total thickness, but different ratios of the materials that comprise the two sections of the article. FIGS. 2g and 2h illustrate articles of the present invention in which the ratios of the two materials are the same, but the overall thicknesses of the articles are different.

The microstructured features and the patterns of the microstructured features may also vary based on the particular embodiment of the invention. For example, in articles having the same overall thickness and same relative ratios of sections, the length of the gradient may differ, as illustrated in FIGS. 2i and 2j. In other embodiments, the lateral spacing of microstructured features may also vary. For example, as illustrated by FIGS. 2k and 2l, the width and number of microstructured features may vary.

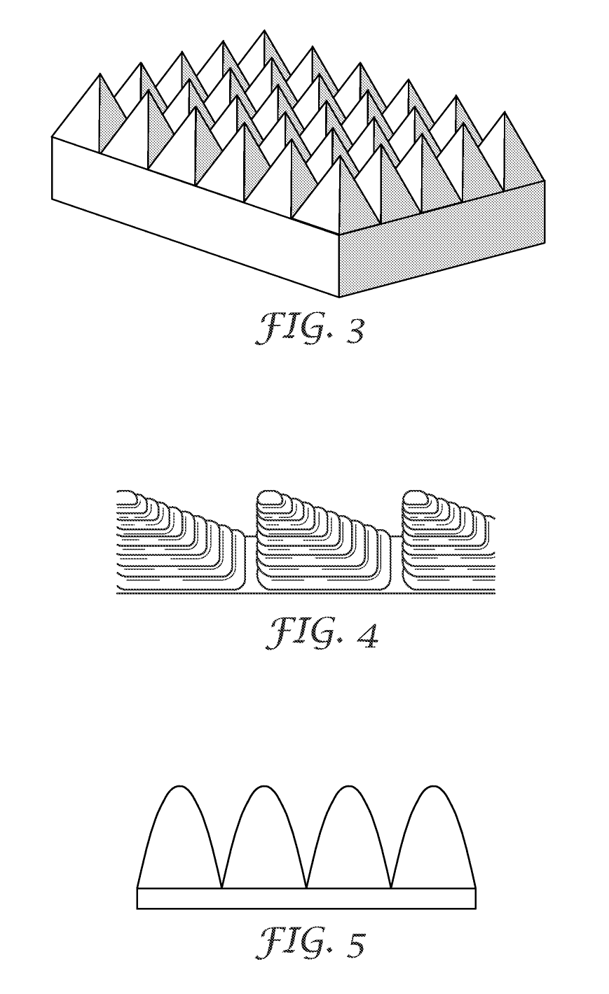

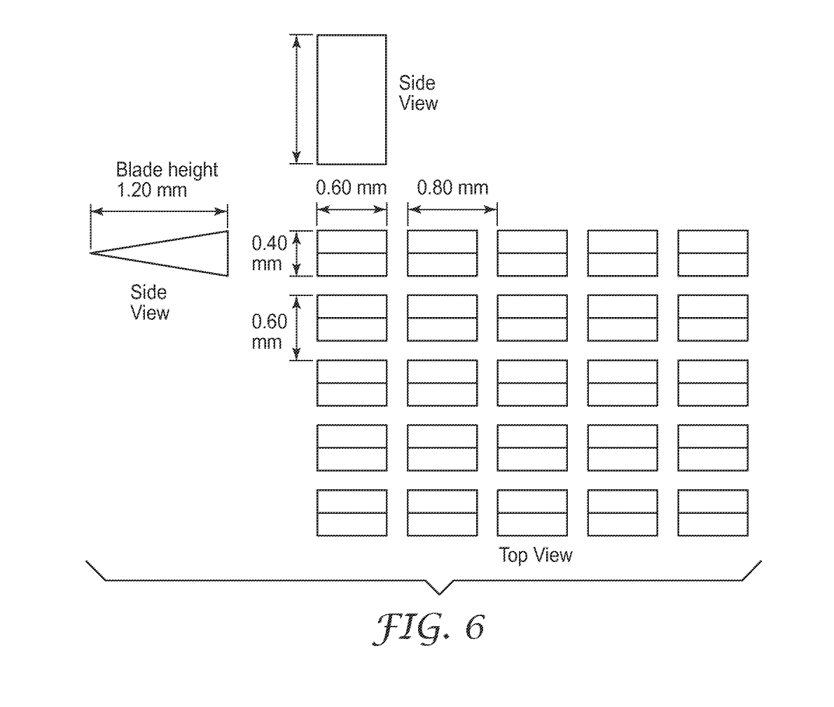

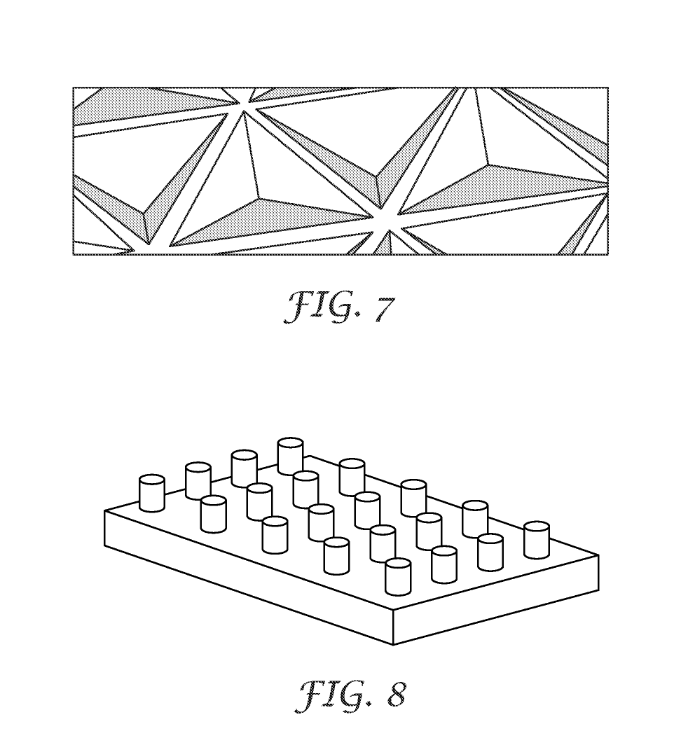

Microstructured features that provide a continuously varying electromagnetic property gradient include features having surfaces non-horizontal and non-vertical to a major axis of the base portion of the section shaving such features. Exemplary features include, but are not limited to, pyramids, such as square-based pyramids (FIG. 3) having acute, 90°, or oblique vertex angles, triangular-based pyramids having acute, oblique, or cube corner vertex angles (FIG. 7), hexagonal based-pyramids, having acute or oblique vertex angles, rotated pyramids, and asymmetric pyramids, which may have offset vertices (e.g., sawtooth pyramids) cones such as cones having circular or ellipsoidal bases, cones having acute, 90°, or oblique vertex angles; paraboloids (FIG. 5), triangular prisms (FIG. 6); and hemispheres. Depending on the type of microstructure employed, the electromagnetic property gradient could vary linearly from one side of the construction to the other. The gradient could also be parabolic, or comprise other functionalities.

Microstructured features providing a step gradient in electromagnetic properties include those having surfaces horizontal and vertical to a major axis of the base portion of the section of the isolator having such features. Exemplary features include, but are not limited to, posts (FIG. 8) including those with round, square, and triangular horizontal cross-sections; parallelepipeds; and other similar block structures having surfaces only parallel and perpendicular (i.e., not sloped) to the base portion of the section. In various embodiments, the lateral spacing of microstructured features and the spacing between the bases of the individual microstructured features may vary.

Some microstructured features have multiple small step changes that effectively provide a gradient in electromagnetic properties. An example of such a structure is the asymmetric stepped pyramid in FIG. 4. Other examples would include shapes that change in multiple small increments.

Some microstructure features or patterns have shapes or arrangements that provide a combination of continuous and step gradients. For example, truncated pyramids and cones would provide a step gradient at its top (horizontal) surface but a continuous gradient at its side (sloped) surfaces. As another example, in the blade array of FIG. 6, the sloped surfaces of the triangular prisms would provide a continuous gradient but the vertical surfaces of the triangular prisms would provide a surface perpendicular to the base of the isolator.

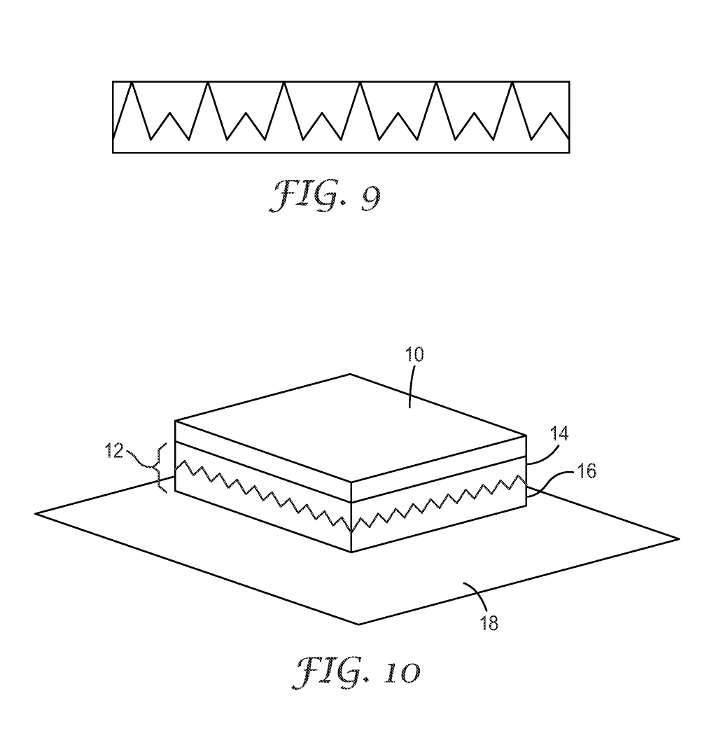

In some embodiments, the patterns of the microstructured features of the present invention may be multi-modal, such as bimodal or trimodal with respect to height (FIG. 9), width, geometry, lateral spacing, periodicity, etc.

The resulting product may take a number of different forms, sometimes depending on the process used to make them. For example, a continuous sheet or web-based process may be used to produce a product in roll form, which can later be cut or sized for specific applications. The resulting product may be molded directly into distinct shapes such as rectangular, oval, or even complex 2-D geometries to minimize waste while catering to a specific product design.

Various methods of microstructuring are suitable for forming the microstructured surface or interface of the present invention. Suitable methods include calendering; high pressure embossing; casting and curing with a mold (e.g., using a high permittivity or permeability material with a binder, which binder is cured after the material is cast on a mold); compression molding (e.g., a mold and a high permittivity or permeability material with a binder are heated, then the mold is pressed against the material); extrusion casting (e.g., a high permittivity or permeability material with a binder is extruded directly into a heated tool, the tool is cooled, and the formed material is removed from the tool); extrusion embossing (e.g., a high permittivity or permeability material with a binder is extruded directly into a cold tool, then removed from the tool); flame embossing (e.g., a flame is used to heat just the surface of a high permittivity or permeability material with a binder, then the surface is microstructured with a tool); and injection molding (e.g., molten high permittivity or permeability material with a binder is injected into a heated mold, then cooled). Each of these systems could then have a material with a contrasting electromagnetic property molded or cured over the microstructured portion. Alternatively, the initial microstructuring could be performed with a material possessing a low permeability and permittivity, and then a material having a contrasting electromagnetic property could be molded or cured over it.

Embodiments of the invention are suitable for use with antennae that operate at ultra high frequency or super high frequency regions. Embodiments of isolators of the present invention may be used in applications such as, but not limited to, cell phones, communication antennae, wireless routers, and RFID tags.

Embodiments of the invention find particular use in applications involving far-field electromagnetic radiation, such as when isolating RFID chips from metallic or other conductive surfaces. The isolators of the present invention are well-suited for applications using electromagnetic wavelengths that are much longer than the periodicity of the microstructured pattern or much longer than the microstructured pattern height

Aspects of this invention include systems using the isolators of this invention to isolate RFID tags from a conductive surface or body. Passive UHF RFID tag antennas are optimized for use in free space or on low dielectric materials, such as corrugated cardboard, pallet wood, etc. When a UHF RFID tag is in proximity to a conductive surface or body, the impedance and gain of the tag antenna changes, greatly decreasing its ability to power up and respond to the reader.

An isolator placed between the conductive substrate and RFID tag can ameliorate the effects of the metallic substrate by effectively increasing the distance between the tag and substrate (high permeability and/or permittivity), and by reducing the ability of the antenna's magnetic field from interacting with the conductive substrate (and vice-versa). The presence of the isolator can change not only the antenna gain, but also the effective impedance of the antenna, thus changing the amount of power transferred from the antenna to the RFID IC and, ultimately, the power modulated and backscattered to the RFID reader. Because of these and other complex interactions, isolator design is specific to a specific RFID tag. Similar arguments hold for other types of antennae close to conductive materials, such as a cell phone antenna proximate circuitry, or a metallic housing or ground plane.

RFID tags come in a myriad of different designs to meet a variety of customer needs. Some of the differences in RFID IC design are related to their differences in power, memory, and calculation ability. RFID antenna design is dictated by a number of factors including the need to match impedances with the IC, desired read distances, footprint minimization, footprint aspect ratio, and orientation dependence on response. RFID tags of numerous designs can be purchased from any of a number of companies, such as Intermec Technologies Corporation, Alien Technology, Avery-Dennison, and UPM Raflatac.

A UHF RFID tag typically operates in the frequency range between 865 and 954 MHz, with the most typical center frequencies being 869 MHz, 915 MHz and 953 MHz. The RFID tag can be self-powered by inclusion of a power source, such as a battery. Alternatively, it can be field-powered, such that it generates its internal power by capturing the energy of the electromagnetic waves being transmitted by the base station and converting that energy into a DC voltage.

The isolators of the present invention are most useful when the electrical properties of article to be tagged will interfere with the operation of the RFID tag. This will most often occur when the article to be tagged comprises a metal substrate, or is configured to contain liquids, which are both problematic with respect to read distances.

FIG. 10 illustrates a system of the present invention including an RFID tag 10, an isolator 12 comprising sections 14 and 16, and an article to be tagged 18. Adhesive layers (not shown) may additionally be added between RFID tag 10 and section 14 and/or section 16 and article to be tagged 18, if the relevant isolator section 14, 16 does not have sufficient adhesive properties to adhere to the RFID tag or article to be tagged 18.

### EXAMPLES

This invention is illustrated by the following examples, but the particular materials and amounts thereof recited in these examples, as well as other conditions and details should not be construed to unduly limit this invention.

### Test and Measurement Methods

### Equivalent Thickness Calculation

“Equivalent thickness” means the thickness that a section would be if the microstructured structures were flattened to create a solid section with no microstructured features.

NOTE: In all examples in which an RFID system was made, one layer of double stick tape (SCOTCH 665, 3M Company) was adhered between the metal substrate (either an aluminum plate or 3M™ EMI Tin-Plated Copper Foil Shielding Tape 1183 (hereafter sometimes referred to as “1183 Tape”), available from 3M Company) and the isolator to ensure the isolator remained adhered to the metal substrate.

### Examples 1-3 and Comparative Examples (CE) A-F

### Preparation of Comparative Examples A-F

TiO₂ (TIPURE R-902+, Dupont Inc., www2.dupont.com) was blended into silicone (SYLGARD 184, Dow Corning, www.dowcorning.com) at the rate of 58 weight % TiO₂/42 weight % silicone and cured into monolithic 2.5 cm×10 cm slabs at various thicknesses. Carbonyl iron powder (ER Grade, BASF, www.inorganics.basf.com) was blended into silicone (SYLGARD 184, Dow Corning, www.dowcorning.com) at the rate of 85 weight % carbonyl iron/15 weight % silicone and cured into monolithic 2.5 cm×10 cm slabs at various thicknesses. Comparative Examples A through C had a 58% TiO₂/silicone blend section of 0.51 mm thick, and carbonyl iron/silicone blend section thicknesses of 0.72, 1.02, and 1.29 mm, respectively. Comparative Examples D through F had a 58% TiO₂/silicone blend section of 0.72 mm thick, and carbonyl iron/silicone blend section thicknesses of 0.48, 0.72, and 1.02 mm, respectively.

### Preparation of Example 1

A nickel mold comprising 0.75 mm deep conical features arranged in a 0.65 mm hexagonal close-packed spacing was fabricated. The hexagonal close-packed array covered a 2.5 cm×10 cm area. 58% by weight TiO₂ (TIPURE R-902+, Dupont Inc., www2.dupont.com) was blended into a silicone system (SYLGARD 184, Dow Corning, www.dowcorning.com), cured in the mold, and then removed. The thickness of the TiO₂/silicone base portion below the cones was 0.28 mm thick. With the 0.75 mm high cones, the equivalent thickness of the overall TiO₂ section was 0.53 mm. Then, 85% by weight carbonyl iron powder (ER Grade, BASF, www.inorganics.basf.com) was blended into silicone (SYLGARD 184, Dow Corning, www.dowcorning.com) and the blend was applied to fill the space around and just above the TiO₂-filled cones. To create a smooth surface, the blend was added beyond the tops of the 0.75 mm tall cones by about 0.29 mm. Subsequently, the blend was cured.

### Preparation of Examples 2-3

Monolithic slabs prepared in the same manner as for Comparative Examples A-F having 85 weight % ER Grade carbonyl iron/15% silicone were placed against the carbonyl iron side of Example 1 to increase the thickness of the carbonyl iron section for Examples 2 and 3. The monolithic slab thicknesses for Examples 2 and 3 were 0.27 mm and 0.48 mm, respectively. No adhesive was necessary to hold the finished article together due to the adhesion properties of the silicone.

### RFID Systems using Comparative Examples A-F and Examples 1-3

RFID tag systems using Comparative Examples A-F and Examples 1-3 were made using Avery Dennison 210 Runway RFID tags operating with the Gen 2 protocol. The tags were read from 902-928 MHz proximate a 12.5 mm thick aluminum plate. The RFID tag system was constructed with the following sequence of adjacent sections: aluminum plate/TiO₂-filled section of isolator/carbonyl iron-filled section of isolator/RFID tag. This system was moved at various positions in front of an ALR-9780 Alien Reader until a 75% RFID tag read rate was obtained. For each Comparative Example and Example, the distance from the ALR-9780 reader at a 75% read rate was determined at three independent readings and then averaged.

The read range data for the Comparative Examples are shown in Table 1. The second and third columns show the actual thicknesses of the TiO₂/silicone blend section and the carbonyl iron/silicone blend sections, respectively. Table 1 shows that the read range increased monotonically as the carbonyl iron section thickness increased from 0.72 to 1.29 mm for a TiO₂ section thickness of 0.51 mm. Similarly, the read range increased monotonically as the carbonyl iron section thickness increased from 0.48 to 1.02 mm when the TiO₂ section was 0.73 mm thick.

The read range data for the Examples are shown in Table 2. The second and third columns give equivalent thicknesses of the TiO2 and carbonyl blend sections, respectively. The read range increased monotonically as the equivalent carbonyl iron section thickness increased from 0.79 to 1.27 mm with an effective TiO₂ section thickness of 0.53 mm.

The read range versus isolator thickness for comparative Examples A-F and Examples 1-3 are plotted together in FIG. 11. The data points on the solid line represent, from left to right, Examples 1, 2, and 3. The data points on the line with large dashes represent, from left to right, Comparative Examples A, B, and C. The data points on the line with small dashes represent, from left to right, Comparative Examples D, E, and F. Comparative Examples A-C comprise a TiO₂ section thickness essentially equivalent to that of Examples 1-3. It is clear that, at any given isolator thickness, Examples 1-3 provide a longer read range than that of Comparative Examples A-C. Increasing the TiO₂ section thickness in the Comparative Examples did not show a substantial increase in the read distance, as illustrated in FIG. 11.

TABLE 1

| | | Carbonyl Iron | Total | Carbonyl Iron | Read |
|---|---|---|---|---|---|
| | TiO₂ Section | Section | Thickness | Section | Range |
| Example | Thickness (mm) | Thickness (mm) | (mm) | Fraction | (cm) |
| CE A | 0.51 | 0.72 | 1.23 | 0.59 | 46 |
| CE B | 0.51 | 1.02 | 1.53 | 0.67 | 82 |
| CE C | 0.51 | 1.29 | 1.80 | 0.72 | 85 |
| CE D | 0.73 | 0.48 | 1.21 | 0.40 | 27 |
| CE E | 0.73 | 0.72 | 1.45 | 0.50 | 71 |
| CE F | 0.73 | 1.02 | 1.75 | 0.58 | 88 |

TABLE 2

| | Effective TiO₂ | Effective Carbonyl | Total | Carbonyl Iron | Read |
|---|---|---|---|---|---|
| | Section | Iron Section | Thickness | Section | Range |
| Example | Thickness (mm) | Thickness (mm) | (mm) | Fraction | (cm) |
| 1 | 0.53 | 0.79 | 1.32 | 0.60 | 75 |
| 2 | 0.53 | 1.06 | 1.59 | 0.67 | 95 |
| 3 | 0.53 | 1.27 | 1.80 | 0.71 | 99 |

### Examples 4-6 and Comparative Examples (CE) G-O

### Preparation of Comparative Examples G-O

XLD3000 glass bubbles (3M Company, www.3m.com) were blended into silicone (SYLGARD 184, Dow Corning, www.dowcorning.com) at the rate of 15 weight % XLD3000/85 weight % silicone and cured into monolithic 2.5 cm×10 cm slabs at various thicknesses. Carbonyl iron powder (ER Grade, BASF, www.inorganics.basf.com) was blended into silicone (SYLGARD 184, Dow Corning, www.dowcorning.com) at the rate of 85 weight % carbonyl iron/15 weight % silicone and cured into monolithic 2.5 cm×10 cm slabs at various thicknesses. Comparative Examples G through I had a 15 weight % XLD3000/silicone blend section thickness of 0.41 mm, and carbonyl iron/silicone blend section thicknesses of 0.72, 1.02, and 1.29 mm, respectively. Comparative Examples J through L had a 15 weight % XLD3000/silicone blend section thicknesses of 0.49 mm, and carbonyl iron/silicone blend section thicknesses of 0.72, 1.02, and 1.29 mm, respectively. Comparative Examples M through O had a 15 weight % XLD3000/silicone blend section thickness of 0.54 mm, and carbonyl iron/silicone blend section thicknesses of 0.72, 1.02, and 1.29 mm, respectively.

### Preparation of Examples 4

A nickel mold comprising 0.36 mm deep pyramidal features arranged in a 0.59 mm square spacing was fabricated. 85% by weight carbonyl iron powder (ER Grade, BASF, www.inorganics.basf.com) was blended into a silicone system (SYLGARD 184, Dow Corning, www.dowcorning.com), cured in the mold, then removed. The thickness of the carbonyl iron/silicone base portion below the pyramids was 0.70 mm thick. With the 0.36 mm high pyramids, the equivalent thickness of the overall carbonyl iron section was 0.82 mm. 15% by weight XLD3000 glass bubbles (3M Company, www.3m.com) blended into a silicone system (SYLGARD 184, Dow Corning, www.dowcorning.com) was applied to fill the space around and to 0.22 mm above the carbonyl iron filled pyramids and then cured. The total actual thickness of Example 4 was 1.28 mm.

### Preparation of Examples 5-6

Monolithic slabs of 85 weight % ER Grade carbonyl iron/15% silicone were placed against the carbonyl iron side of Example 4 to increase the thickness of the carbonyl iron section to create Examples 5 and 6. The monolithic slab thicknesses for Examples 2 and 3 were 0.27 mm and 0.48 mm, respectively. No adhesive was necessary to hold the finished article together due to the adhesion properties of the silicone.

### RFID Systems using Comparative Examples G-O and Examples 4-6

RFID tag systems using Comparative Examples G-0 and Examples 4-6 were made using UPM Rafsec G2, ANT ID 17B_{—}1, IMPINJ MONZA tags operating with the Gen 2 protocol. The tags were read from 902 to 928 MHz proximate a 12.5 mm thick aluminum plate. The RFID tag system was constructed with the following sequence of adjacent sections: aluminum plate/carbonyl iron-filled section of isolator/glass bubble filled section of isolator/RFID tag. The system was moved at various positions in front of an ALR-9780 Alien Reader until a 75% RFID tag read rate was obtained.

The read range data for the Comparative Examples are displayed in Table 3. The second and third columns show the thicknesses of the glass bubble/silicone blend section and the carbonyl iron/silicone blend sections, respectively. Table 3 shows that the read range increased monotonically as the carbonyl iron section thickness increased from 0.72 to 1.29 mm for glass bubble section thicknesses of 0.41 and 0.49 mm. The read range for the 0.54 mm thick glass bubble section increased up to 50 cm as the carbonyl iron section thickness increased from 0.72 to 1.29 mm.

The read range data for Examples 4-6 of the invention are shown in Table 4. The second and third columns give equivalent thicknesses of the glass bubble and carbonyl iron blend sections, respectively. The UPM Rafsec IMPINJ MONZA tag read range increased monotonically as the equivalent carbonyl iron section thickness increased from 0.82 to 1.30 mm while the glass bubble section thickness remained constant at 0.46 mm.

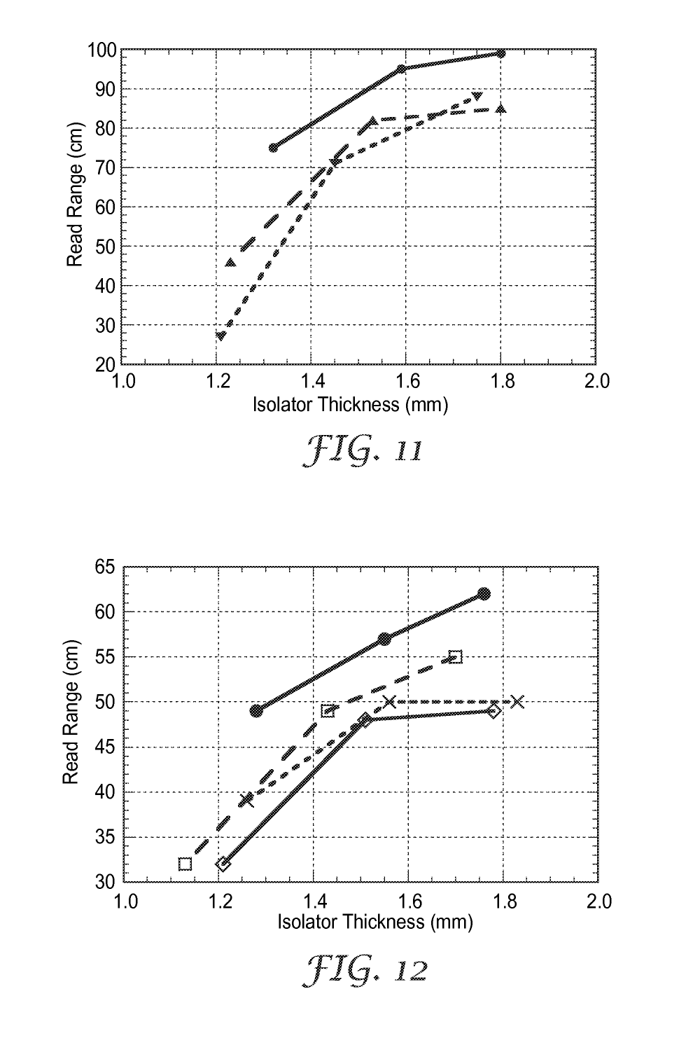

The read range versus isolator thickness for comparative Examples G-0 and Examples 4-6 are plotted together in FIG. 12. The data points on the solid line with solid circles represent, from left to right, Examples 4, 5, and 6. The data points on the line with large dashes represent, from left to right, Comparative Examples G, H, and I. The data points on the solid line with hollow squares represent, from left to right, Comparative Examples J, K, and L. The data points on the line with small dashes represent, from left to right, Comparative Examples M, N, and O. Comparative Examples G-0 comprise glass bubble section thicknesses essentially the same, and just above and below that of Examples 4-6. It is clear that, at any given isolator thickness, Examples 4-6 provide a longer read range than that provided by the equivalent isolator thickness of a sectioned system. Changing the glass bubble section thickness within the range 0.41 to 0.54 mm in the Comparative Examples does not substantially change the read distance, as illustrated in the graph.

TABLE 3

| | Glass Bubble | Carbonyl Iron | Total | Carbonyl Iron | Read |
|---|---|---|---|---|---|
| | Section | Section | Thickness | Section | Range |
| Example | Thickness (mm) | Thickness (mm) | (mm) | Fraction | (cm) |
| CE G | 0.41 | 0.72 | 1.13 | 0.64 | 32 |
| CE H | 0.41 | 1.02 | 1.43 | 0.71 | 49 |
| CE I | 0.41 | 1.29 | 1.70 | 0.76 | 55 |
| CE J | 0.49 | 0.72 | 1.21 | 0.60 | 32 |
| CE K | 0.49 | 1.02 | 1.51 | 0.68 | 48 |
| CE L | 0.49 | 1.29 | 1.78 | 0.72 | 49 |
| CE M | 0.54 | 0.72 | 1.26 | 0.57 | 39 |
| CE N | 0.54 | 1.02 | 1.56 | 0.65 | 50 |
| CE O | 0.54 | 1.29 | 1.83 | 0.70 | 50 |

TABLE 4

| | Effective Glass | Effective Carbonyl | Total | Carbonyl Iron | Read |
|---|---|---|---|---|---|
| | Bubble Section | Iron Section | Thickness | Section | Range |
| Example | Thickness (mm) | Thickness (mm) | (mm) | Fraction | (cm) |
| 4 | 0.46 | 0.82 | 1.28 | 0.64 | 49 |
| 5 | 0.46 | 1.09 | 1.55 | 0.70 | 57 |
| 6 | 0.46 | 1.30 | 1.76 | 0.74 | 62 |

### Examples 7-8 and Comparative Examples P-S

### Preparation of Comparative Examples P-S

BaTiO₃ (TICON P, TAM Ceramics, now Ferro Corp., www.ferro.com) was blended into silicone (SYLGARD 184, Dow Corning, www.dowcorning.com) at the rate of 73.6 weight % BaTiO₃/26.4 weight % silicone and cured into monolithic 2.5 cm×10 cm slabs at various thicknesses. XLD3000 glass bubbles (3M Company, www.3m.com) were blended into silicone (SYLGARD 184, Dow Corning, www.dowcorning.com) at the rate of 15 weight % XLD3000/85 weight % silicone and cured into monolithic 2.5 cm×10 cm slabs at various thicknesses. Comparative Examples P and Q had a 15 wt % XLD3000 glass bubble/silicone blend section thickness of 0.68 mm and a 73.6 wt % BaTiO₃/silicone blend section of 1.81 mm thick. Comparative Examples R and S had a 15 wt % XLD3000 glass bubble/silicone blend section thickness of 0.63 mm and a 73.6 wt % TICON P/silicone blend section of 1.90 mm thick.

### Preparation of Examples 7-8

A nickel mold comprising 0.68 mm deep paraboloidal features arranged in a 0.65 mm hexagonal close-packed spacing was fabricated. The hexagonal close-packed array covered a 2.5 cm×10 cm area. 15% by weight % XLD3000 glass bubbles were blended into a silicone system (SYLGARD 184, Dow Corning, www.dowcorning.com), cured in the mold, and then removed. The thickness of the XLD3000/silicone base below the paraboloids was 0.31 mm thick. With the 0.68 mm high paraboloids, the equivalent thickness of the overall XLD3000 section was 0.65 mm. 73.6% by weight TICON P was blended into silicone, applied to fill in the space around and 1.49 mm, above the XLD3000-filled paraboloids, and cured to create Examples 7 and 8.

### RFID Systems using Comparative Examples P-S and Examples 7-8

RFID tag systems using Comparative Examples P-S and Examples 7-8 were made with Alien ALN-9654-FWRW tags operating with the Gen 2 protocol. The tags were read from 902-928 MHz proximate a foil tape (1183 Tape, 3M Company, www.3m.com) but arranged in different orientations with respect to the foil tape and the RFID tag. The RFID tag system was constructed with different sequences of adjacent sections for different samples, as further described below. The isolator/tag construction was centered in the middle of the 75 mm×125 mm foil tape. The tag was placed 0.80 meters from a transmitting/receiving antenna powered by a SAMSys MP9320 2.8 UHF RFID reader. The percentage of successful reads over a series of 4 separate scans across the 920-928 MHz spectrum at maximum reader power was calculated.

In the RFID systems using Comparative Examples P and Q and in Example 7, the TICON P-filled section was oriented toward the foil tape. In the RFID systems using Comparative Examples R and S and in Example 8, the TICON P-filled section was oriented toward the RFID tag. The read rate data for the Comparative Examples are displayed in Table 5. Read rate data for the Examples are displayed in Table 6.

Table 5 illustrates that, for a glass bubble/silicone blend sectioned with a barium titanate/silicone blend at a total thickness of about 2.5 mm and a barium titanate/silicone blend fraction of 0.74, the read rates are very poor when the barium titanate-filled section is oriented toward the foil tape. When the barium titanate-filled section is oriented toward the RFID tag, the read rate is still poor when the barium titanate section fraction is only 0.73 and the total thickness is 2.49 mm. When the total thickness is increased to 2.53 mm while further increasing the barium titanate section fraction to 0.75, the read rate increases to 69%. In this instance, the orientation of the comparative isolator construction can therefore be very important.

Table 6 shows that Examples 7 and 8 perform better than their Comparative Example sectioned counterparts. When the barium titanate-filled section is oriented toward the foil tape, the read rate is far superior for Example 7 vs. Comparative Examples P and Q. When the barium titanate-filled section is oriented toward the RFID tag, the read rate is still shown to be better for Example 8 vs. Comparative Examples R and S. In fact, Examples 7 and 8 both perform better than any of Comparative Examples P to S.

TABLE 5

| | | Glass Bubble | TICON P | Total | | |
|---|---|---|---|---|---|---|
| | TICON P | Section Thickness | Section Thickness | Thickness | TICON P | |
| Example | Section Against | (mm) | (mm) | (mm) | Section Fraction | Read Rate |
| CE P | Metal | 0.68 | 1.81 | 2.49 | 0.73 | <2% |
| CE Q | Metal | 0.63 | 1.90 | 2.53 | 0.75 | 14% |
| CE R | Tag | 0.68 | 1.81 | 2.49 | 0.73 | <2% |
| CE S | Tag | 0.63 | 1.90 | 2.53 | 0.75 | 69% |

TABLE 6

| | | | Effective | | | |
|---|---|---|---|---|---|---|
| | | Effective | TICON P | Total | | |
| | TICON P | Glass Bubble | Section Thickness | Thickness | TICON P | |
| Example | Section Against | Section (mm) | (mm) | (mm) | Section Fraction | Read Rate |
| 7 | Metal | 0.65 | 1.83 | 2.48 | 0.74 | 73% |
| 8 | Tag | 0.65 | 1.83 | 2.48 | 0.74 | 76% |

### Example 9

### Preparation of Example 9

A nickel mold comprising inverse asymmetric pyramids was created utilizing conventional stereolithography techniques followed by nickel plating. The apex of the pyramid was fabricated directly over one corner of the pyramid base (see, e.g., FIG. 4), and a square array of these pyramids was created with all apexes in the same orientation. The stair-stepped features of the asymmetric pyramids created a series of 10 steps on a 1.21 mm square base. Fifteen weight percent XLD3000 glass bubbles were blended into SYLGARD 184, cured in the mold, and then removed. The height of these stair-stepped, asymmetric pyramids comprising the XLD3000/silicone blend was 0.546 mm. The thickness of the XLD3000/silicone base portion below the asymmetric pyramids was 0.134 mm. With the 0.546 mm high asymmetric pyramids, the equivalent thickness of the overall XLD3000/silicone section was 0.32 mm. Eighty-five weight percent ER Grade carbonyl iron powder was blended into SYLGARD 184 and then cured. This isolator construction was trimmed to a 45×100 mm area. The total thickness of the finished article was 1.50 mm.

### RFID System using Example 9

An RFID tag systems using Example 9 was made with an RSI-122 dual dipole tag (40×80 mm) operating with the Gen 2 protocol. The tag was held in place on the isolator by a combination of the natural adhesion properties of the silicone and a thin strip of tape over the top of the tag. The tag was read from 902-928 MHz proximate a foil tape (1183 Tape) in an anechoic chamber. The isolator/tag construction was centered in the middle of a 75 mm×125 mm piece of foil tape with the carbonyl iron section against the foil tape. The tag was placed 0.70 meters from a transmitting/receiving antenna powered by a SAMSys MP9320 2.8 UHF RFID reader. The minimum power required to obtain a response from the tag was determined across the 920-928 MHz spectrum and averaged over 4 separate scans.

With overall thickness of the isolator construction at 1.50 mm, the equivalent thickness of the carbonyl iron section was 1.18 mm, and the equivalent thickness of the XLD3000 section was 0.32 mm. The tag/isolator/foil tape construction was read successfully across the entire spectrum, with an average minimum power of 26.9 dBm from the SAMSys reader.

### Example 10

### Preparation of Example 10

A nickel mold comprising inverse paraboloids of two different heights and widths was created. Fifteen weight percent XLD3000 glass bubbles were blended into SYLGARD 184, cured in the mold, and then removed. The larger paraboloid cavities created features 0.765 mm in height and 0.590 mm base width. The smaller paraboloid cavities created features 0.250 mm in height and 0.323 mm in base width. These two disparate-sized and -aspect ratio paraboloids were arranged in a regularly alternating square array with a unit cell length of 1.192 mm. The thickness of the XLD3000/silicone base portion below the bimodal distribution of paraboloids was 0.201 mm. With the bimodal distribution of paraboloids, the equivalent thickness of the overall XLD3000/silicone section was 0.363 mm. Eighty-five weight percent R1521 carbonyl iron powder (ISP Corp, www.ispcorp.com) was blended into SYLGARD 184, applied to fill in the space around and 0.254 mm above, the XLD3000-filled paraboloids, and then cured. This isolator construction was trimmed to a 25×100 mm area.

### RFID System using Example 10

An RFID tag systems using Example 10 was made with an ALN-9654 tag operating with the Gen 2 protocol. The tag was held in place on the isolator by a combination of the natural adhesion properties of the silicone and a thin strip of tape over the top of the tag. The tag was read from 902-928 MHz proximate a foil tape (1183 Tape) in an anechoic chamber. The isolator/tag construction was centered in the middle of a 75 mm×125 mm piece of the foil surface with the carbonyl iron section against the RFID tag. The tag was placed 0.80 meters from a transmitting/receiving antenna powered by a SAMSys MP9320 2.8 UHF RFID reader. The minimum power required to obtain a response from the tag was determined across the 920-928 MHz spectrum and averaged over 4 separate scans.

With the overall thickness of the isolator construction at 1.22 mm, the equivalent thickness of the carbonyl iron section was 0.86 mm, and the equivalent thickness of the XLD3000 section was 0.36 mm. The tag/isolator/foil tape construction was read successfully across the entire spectrum, with an average minimum power of 25.7 dBm from the SAMSys reader.

### Example 11

### Preparation of Example 11

An anisotropic, flake-shaped high permeable ferrite filler material (91 wt %) was mixed with an acrylate copolymer binder (9 wt %). Ten parts by weight Co2Z-K ferrite (Trans-Tech Inc, www.trans-techinc.com) was blended with 0.98 parts by weight acrylate copolymer (90 weight percent isooctyl acrylate/10 weight percent acrylic acid) and 6.41 parts by weight solvent (50 weight percent heptane/50 weight percent methyl ethyl ketone). This solution was cast, dried, and then hot pressed to remove any entrained voids. A CO₂ laser was used to drill 0.70 mm diameter holes forming a 1.30 mm square array into a 0.85 mm thick slab of this 91 weight percent ferrite/9 weight percent acrylate copolymer material. A 0.52 mm thick slab of the same material was created, and both constructions were trimmed to 25×100 mm and adhered together by pressing the somewhat pressure sensitive adhesive slabs together.

### RFID System using Example 11

An RFID tag systems using Example 1 lwas made with an ALN-9654 tag operating with the Gen 2 protocol. The tag was held in place on the isolator by a combination of the natural adhesion properties of the acrylate and a thin strip of tape over the top of the tag. The tag was read from 902-928 MHz proximate a foil tape (1183 Tape) in an anechoic chamber. The isolator/tag construction was centered in the middle of a 75 mm×125 mm 1183 piece of foil tape with the 0.52 mm thick monolithic ferrite/acrylate slab against the foil tape and the 0.85 mm thick slab with the unfilled drilled holes against the RFID tag. The tag was placed 0.80 meters from a transmitting/receiving antenna powered by a SAMSys MP9320 2.8 UHF RFID reader. The minimum power required to obtain a response from the tag was determined across the 920-928 MHz spectrum and averaged over 8 separate scans.

With an overall thickness of the isolator construction at 1.37 mm, the equivalent thickness of the ferrite section was 1.18 mm, and the equivalent thickness of the air section was 0.19 mm. The tag/isolator/foil tape construction was read successfully across the entire spectrum, with an average minimum power of 23.8 dBm from the SAMSys reader.

### Example 12

### Preparation of Example 12

133.5 grams ER Grade carbonyl iron powder was blended with 19.95 grams thermoplastic polymer ENGAGE 8401 (The Dow Chemical Company, www.dow.com) in a Haake mixer at 150° C. This material was pressed into a nickel mold comprising inverted pyramids at 150° C. to produce a carbonyl iron/thermoplastic blend isolator with a flat surface on one side and microstructured surface having pyramidal projections on the other side. The length and spacing of these pyramids was 0.588 mm and the pyramid height was 0.349 mm. The total thickness of the construction was 0.98 mm. The sample was trimmed to 25×100 mm.

### RFID System using Example 12

An RFID tag systems using Example 12 was made with an ALN-9654 tag operating with the Gen 2 protocol. The tag was held in place on the isolator by a thin strip of tape over the top of the tag. The tag was read from 902-928 MHz proximate a foil tape (1183 Tape) in an anechoic chamber. The isolator/tag construction was centered in the middle of a 75 mm×125 mm 1183 piece of foil tape with the microstructured surface of the isolator facing the foil tape. The tag was placed 0.80 meters from a transmitting/receiving antenna powered by a SAMSys MP9320 2.8 UHF RFID reader. The minimum power required to obtain a response from the tag was determined across the 920-928 MHz spectrum and averaged over 4 separate scans.

The equivalent thickness of the carbonyl iron/thermoplastic section was 0.75 mm, and the equivalent thickness of the air section surrounding the pyramids was 0.23 mm. The tag/isolator/foil tape construction was read successfully across the entire spectrum, with an average minimum power of 27.7 dBm from the SAMSys reader.

### Example 13

### Preparation of Example 13

A nickel mold comprising tetrahedra on a hexagonal close packed lattice was created. Eighty-five weight percent HQ grade carbonyl iron powder (BASF, www.inorganics.basf.com) was blended into SYLGARD 184 and then cured in this mold to create tetrahedral indentations in the surface of the carbonyl iron/silicone blend section. The indentations were 0.20 mm deep and 0.29 mm from apex to apex. The overall thickness of this isolator construction was 1.04 mm. This isolator was trimmed to a 25×100 mm area.

### RFID System using Example 13

An RFID tag systems using Example 13 was made with an ALN-9654 tag operating with the Gen 2 protocol. The tag was held in place on the isolator by a thin strip of tape over the top of the tag. The tag was read from 902-928 MHz proximate a foil tape (1183 Tape) in an anechoic chamber. The isolator/tag construction was centered in the middle of a 75 mm×125 mm 1183 Tape foil surface with the carbonyl iron section against the RFID tag. The tag was placed 0.80 meters from a transmitting/receiving antenna powered by a SAMSys MP9320 2.8 UHF RFID reader. The minimum power required to obtain a response from the tag was determined across the 920-928 MHz spectrum and averaged over 4 separate scans.

With an overall thickness of the isolator construction at 1.04 mm, the equivalent thickness of the carbonyl iron section was 0.97 mm, and the equivalent thickness of the air section was 0.07 mm. The tag/isolator/foil tape construction was read successfully across the entire spectrum, with an average minimum power of 19.5 dBm from the SAMSys reader.

### Example 14

### Preparation of Example 14

EW-I Grade carbonyl iron powder (BASF, www.inorganics.basf.com) at 94.2 weight percent was blended into a polyolefin available under the trade designation ADFLEX V 109 F (Lyondell Basell, www.alastian.com) in a Brabender batch mixer at 160° C., then pressed into a flat sheet. Two nickel molds identical to those used in Example 13 were utilized to press the flat sheet into an isolator comprising microstructured tetrahedral indentations on both sides. The overall thickness of this construction was 0.69 mm. This isolator was trimmed to a 25×100 mm area.

### RFID System using Example 13

An RFID tag systems using Example 13 was made with an ALN-9654 tag operating with the Gen 2 protocol. The tag was held in place on the isolator by small strips of tape over the top of the tag. The tag was read from 902-928 MHz proximate a foil tape (1183 Tape) in an anechoic chamber. The isolator/tag construction was centered in the middle of a 75 mm×125 mm foil tape with the carbonyl iron section against the RFID tag. The tag was placed 0.80 meters from a transmitting/receiving antenna powered by a SAMSys MP9320 2.8 UHF RFID reader. The minimum power required to obtain a response from the tag was determined across the 920-928 MHz spectrum and averaged over 4 separate scans.

With an overall thickness of the isolator construction at 0.69 mm, the equivalent thickness of the carbonyl iron section was 0.56 mm, and the equivalent thickness of the air section on each side was 0.07 mm. The tag/isolator/foil tape construction was read successfully across the entire spectrum, with an average minimum power of 20.3 dBm from the SAMSys reader.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. This application is intended to cover any adaptations or variations of the preferred embodiments discussed herein. Therefore, it is manifestly intended that this invention be limited only by the claims and the equivalents thereof.

What is claimed is:

1. An article comprising:
an electromagnetic wave isolator comprising at least a first section having first and second major surfaces and an adjacent second section having first and second surfaces, wherein at least one of the sections has a microstructured major surface.

2. The article of claim 1 wherein the microstructured surface of the at least one section faces away from the adjacent second section.

3. The article of claim 1 wherein the microstructured surface of the at least one section faces toward the adjacent second section.

4. The article of claim 1 wherein both the first and second sections have a microstructured surface.

5. The article of claim 1 wherein both the first and second sections have microstructured surfaces that form a microstructured interface.

6. The article of claim 1 wherein at least one section has microstructured first and second major surfaces.

7. The article of claim 1 further comprising a third section having first and second major surfaces, the third section being adjacent to one or both of the first or second section.

8. An article comprising:
an electromagnetic wave isolator comprising at least a first section having first and second major surfaces and an adjacent second section having first and second surfaces, wherein at least one of the sections has microstructured features on at least one major surface;
a component that does one or both of receive an electromagnetic wave and generate an electromagnetic wave, the component coupled to the electromagnetic wave isolator;
wherein when a wave generated or received by the component is within one or more sections of the isolator, the wave has a wavelength that is greater than the periodicity of the microstructured features on at least one major surface of a section of the electromagnetic wave isolator.

9. The article of claim 8 wherein when a wave generated or received by the component is within one or more sections of the isolator, the wave has a wavelength that is greater than the periodicity and height of the microstructured features on at least one major surface of a section of the electromagnetic wave isolator.

10. The article of claim 8 wherein air is located between a portion of the electromagnetic wave isolator and the component.

11. The article of claim 8 wherein the material comprising the first section is different from the material comprising the second section.

12. The article of claim 11 wherein the material comprising the first section is carbonyl iron-filled resin and the material comprising the second section is glass bubble-filled resin.

13. The article of claim 1 or 8 wherein at least one section of the isolator comprises a high permittivity material or a high permeability material.

14. The article of claim 1 or 8 wherein the first and second sections of the isolator comprise materials having different permittivities and the ratio of permittivities of the first and second sections of the isolator is about 2.5 to about 1000.

15. The article of claim 1 or 8 wherein the first and second sections of the isolator comprise materials having different permeabilities and the ratio of permeabilities of the first and second section of the isolator is about 3 to about 1000.

16. The article of claim 1 or 8 wherein at least one section comprises a microstructured portion and a base portion and the microstructured surface comprises features having surfaces non-horizontal and non-vertical with respect to a major axis of the base portion.

17. The article of claim 1 or 8 wherein at least one section comprises a microstructured portion and a base portion and the microstructured surface comprises features having surfaces horizontal and vertical with respect to a major axis of the base portion.

18. The article of claim 1 or 8 wherein the microstructured surface comprises features wherein one or more of the height, width, depth and periodicity of the features is about 1 to about 2000 micrometers.

19. The article of claim 1 or 8 wherein the microstructured surface comprises distances of about 1 to about 2000 micrometers between the bases of the individual features forming the microstructured surface.

20. The article of claim 1 or 8 wherein the microstructured surface comprises at least two different types of features.
